(19) United States
(12) Patent Application Publication
(10) Pub. No.: US 2012/0004840 A1
(43) Pub. Date: Jan. 5, 2012

(54) SYSTEM AND METHOD FOR COMPUTING NECESSARY TIME FOR TRAVEL BASED ON WAITING TIME

(75) Inventors: Chae Hyun LEE, Seongnam-si (KR); Seong Su LEE, Seoul (KR)

(73) Assignee: NHN CORPORATION, Seongnam-si (KR)

(21) Appl. No.: 13/173,046

(22) Filed: Jun. 30, 2011

(30) Foreign Application Priority Data
Jun. 30, 2010 (KR) 10-2010-0062820

(51) Int. Cl. G01C 21/00; G01C 21/34

(52) U.S. Cl. 701/200

(57) ABSTRACT

Provided are a system and method for computing a total travel time according to a transportation type, based, in part, on a waiting time to wait for traveling in the transportation. A system for computing a necessary time for travel may include an input unit to receive a starting point and a destination point, and a necessary time computing unit to compute a necessary time taken to travel from the starting point to the destination point, by adding a waiting time and a travel time, thereby minimizing an error in computing the necessary time for travel.

### CROSS REFERENCE TO RELATED APPLICATION

This application claims priority from and the benefit of Korean Patent Application No. 10-2010-0062820, filed on Jun. 30, 2010, which is hereby incorporated by reference for all purposes as if fully set forth herein.

### BACKGROUND OF THE INVENTION

1. Field of the Invention

Exemplary embodiments of the present invention relate to a system and a method for computing a necessary time for travel and, more particularly, to a system and method that may reduce an error in computing the necessary time for travel using a total travel time and a waiting time.

2. Discussion of the Background

A wayfinding service may be used to search for a travel route and a time required to travel from a starting point to a destination point and to provide information found as a result of the searching in response to a user entering the starting point and the destination point. Hereinafter, a user may refer to a person using the wayfinding service.

When the user travels in a car, a time computed using the wayfinding service may be similar to an actual time taken to travel to the destination by car. However, when public transportation is used by the user, an error may occur in computing the actual time due to additional factors, such as, for example, wait time, while using the public transportation.

For example, when the user uses different subway trains to move from the same starting point to the same destination point, a difference in arrival time may occur because waiting times while riding the subway trains may differ from one train to another due to a difference in arrival times and waiting times.

Accordingly, a system and method to compute a necessary time for travel based on a waiting time according to the user transportation is needed, and a system and method to reduce an error between the computed necessary time and a time actually required for travel is needed.

### SUMMARY OF THE INVENTION

Exemplary embodiments of the present invention provide a system and method to compute a necessary time for travel by adding up a waiting time taken until a user rides in a transportation used to move from a starting point to a destination point, and a travel time taken by the transportation, thereby minimizing an error between the computed necessary time and a time actually required for travel.

Exemplary embodiments of the present invention also provide a system and method to compute a necessary time for travel for each of a plurality of transportations, and may display the plurality of transportations in an order from shortest to longest necessary times, so that a user may select an optimal transportation from among the plurality of transportations.

Additional features of the invention will be set forth in the description which follows, and in part will be apparent from the description, or may be learned by practice of the invention.

Exemplary embodiments of the present invention disclose a system to compute a necessary time for travel, the system includes an input unit, a necessary time computing unit, and a display unit. The input unit receives a starting point and a destination point. The necessary time computing unit computes, for each transportation, a necessary time by adding a waiting time and a travel time. The necessary time including a travel time from the starting point to the destination point. The waiting time includes a time until a transportation is used to travel to the destination point. The travel time includes a time taken by the transportation to travel from the starting point to the destination point. The display unit displays each transportation and a necessary time for each transportation, based on the necessary time computed by the necessary time computing unit.

Exemplary embodiments of the present invention also disclose a method for computing a necessary time for travel. The method includes receiving a starting point and a destination point, and computing, for each transportation, a necessary time by adding a waiting time and a travel time. The necessary time includes a time to travel from the starting point to the destination point. The waiting time includes a time until a transportation is used to travel to the destination point. The travel time includes a time taken by the transportation to travel from the starting point to the destination point. The method further includes displaying each transportation and a necessary time for each transportation, based on the computed necessary time.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a configuration of a necessary travel time computing system according to exemplary embodiments of the present invention.

FIG. 2 is a block diagram illustrating a configuration of a taxi necessary time computing unit of FIG. 1 according to exemplary embodiments of the present invention.

FIG. 3 is a diagram illustrating an example of an operation by which the taxi necessary time computing unit of FIG. 1 collects statistical information and generates a waiting time zone according to exemplary embodiments of the present invention.

FIG. 4 is a diagram illustrating an example of an operation by which the taxi necessary time computing unit of FIG. 1 computes a taxi waiting time using a waiting time zone according to exemplary embodiments of the present invention.

FIG. 5 is a block diagram illustrating a configuration of a subway necessary time computing unit of FIG. 1 according to exemplary embodiments of the present invention.

FIG. 6 is a diagram illustrating an example of an operation by which the subway necessary time computing unit of FIG. 1 computes a walking time according to exemplary embodiments of the present invention.

FIG. 7 is a diagram illustrating an example of an operation by which the subway necessary time computing unit of FIG. 1 computes a transfer walking time according to exemplary embodiments of the present invention.

FIG. 8 is a block diagram illustrating a configuration of a bus necessary time computing unit of FIG. 1 according to exemplary embodiments of the present invention.

FIG. 9 is a diagram illustrating an example of information displayed on a display unit of FIG. 1 according to exemplary embodiments of the present invention.

FIG. 10 is a flowchart illustrating a method of computing a necessary time for travel according to exemplary embodiments of the present invention.

FIG. 11 is a flowchart illustrating a method of computing a taxi waiting time according to exemplary embodiments of the present invention.

FIG. 12 is a flowchart illustrating a method by which a subway waiting time computing unit of FIG. 5 updates a subway operation status according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Detailed descriptions of well-known functions and descriptions incorporated herein may be omitted to avoid obscuring the subject matter of the present invention

The terminology used herein is for the purpose of describing exemplary embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

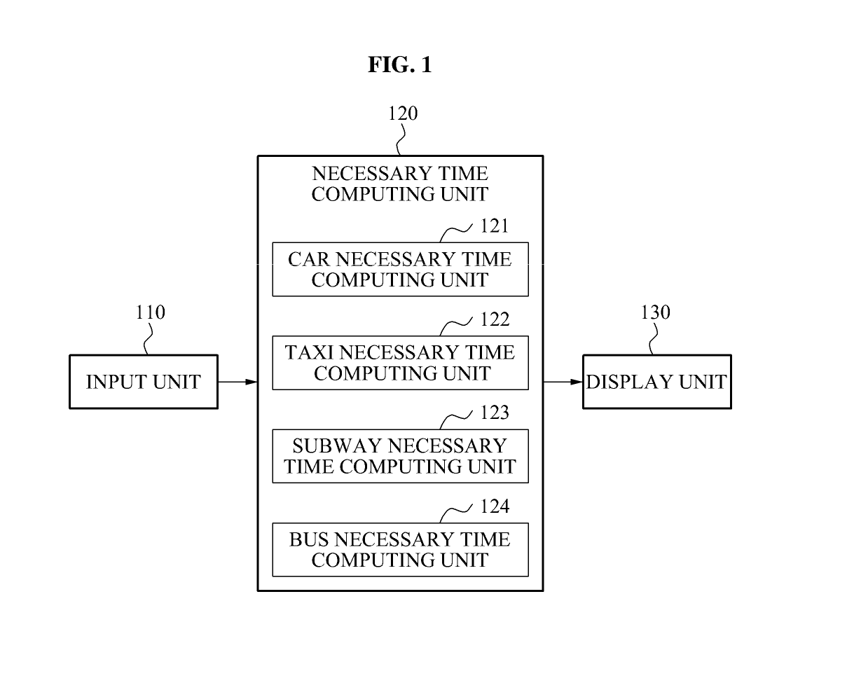

FIG. 1 illustrates a block diagram of a configuration of a necessary travel time computing system according to exemplary embodiments of the present invention.

The necessary travel time computing system of FIG. 1 may compute a necessary time for travel by adding up a waiting time taken until a user rides in a transportation used to travel from a starting point to a destination point, and a travel time taken by the transportation. Thus, it is possible to minimize an error in computing the necessary time for travel.

Referring to FIG. 1, the travel time computing system may include an input unit 110, a necessary time computing unit 120, and a display unit 130.

The input unit 110 may receive information regarding a starting point and a destination point, which may be entered by a user.

The necessary time computing unit 120 may compute a necessary time taken to travel from the starting point to the destination point.

The necessary time computing unit 120 may compute the necessary time by adding up a waiting time taken until the user rides in a transportation to the destination point, and a travel time taken by the transportation to travel to the destination point.

The necessary time computing unit 120 may include a car necessary time computing unit 121, a taxi necessary time computing unit 122, a subway necessary time computing unit 123, and a bus necessary time computing unit 124.

The car necessary time computing unit 121 may compute a necessary time taken to travel from the starting point to the destination point based on real-time traffic information regarding a route from the starting point to the destination point or based on an average speed of a road, when the user rides in a car.

The car necessary time computing unit 121 may divide the route from the starting point to the destination point into a plurality of sections.

The car necessary time computing unit 121 may compute a time taken to travel a section where real-time traffic information is to be acquired among the plurality of sections, based on the real-time traffic information.

The car necessary time computing unit 121 may compute a time taken to travel a section where real-time traffic information is not available among the plurality of sections, based on an average speed for each road of the section. The average speed for each road may be a reference speed set for each road, for example 100 Kilometers (Km) for a highway, 80 km for a four-lane national road, and 60 km for a two-lane national road.

The car necessary time computing unit 121 may add up necessary times computed for each of the plurality of sections of the route, and may compute the necessary time taken to travel from the starting point to the destination point when the user rides in the car.

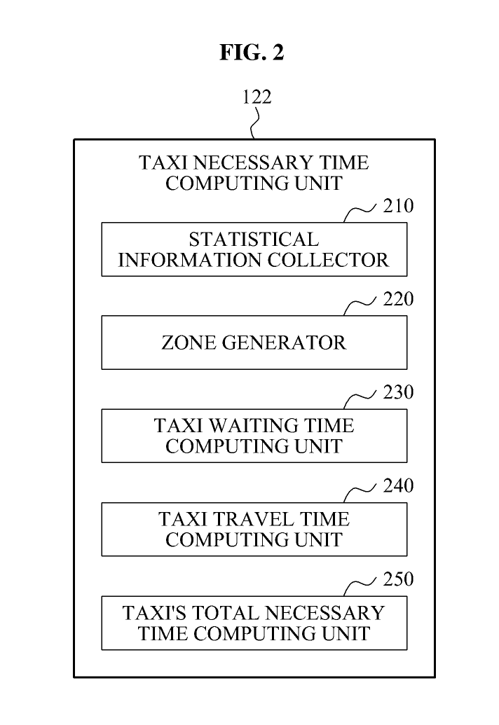

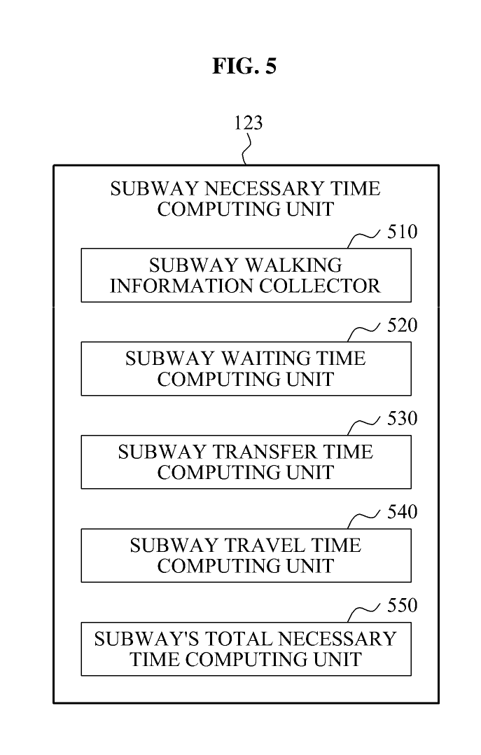

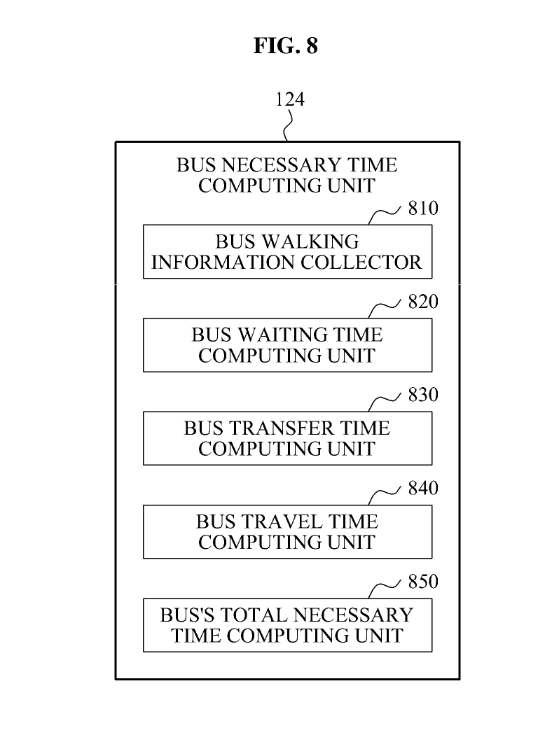

The taxi necessary time computing unit 122, the subway necessary time computing unit 123, and the bus necessary time computing unit 124 will be further described with reference to FIG. 2, FIG. 5, and FIG. 8.

The display unit 130 shown in FIG. 1 may display types of transportations, and necessary times for each type of the transportation, based on the necessary time computed by the necessary time computing unit 120.

The display unit 130 may display, first, a transportation with a shortest necessary time and may display other transportations in an order of increasing necessary times (e.g., from shortest to longest times).

FIG. 2 illustrates a block diagram of a configuration of the taxi necessary time computing unit 122 of FIG. 1.

The taxi necessary time computing unit 122 may be configured to compute a necessary time if the user transportation is via taxi. As shown in FIG. 2, the taxi necessary time computing unit 122 may include a statistical information collector 210, a zone generator 220, a taxi waiting time computing unit 230, a taxi travel time computing unit 240, and a taxi's total necessary time computing unit 250.

The statistical information collector 210 and the zone generator 220 may be used to estimate an approximate waiting time based on statistics, when it is difficult to verify location information of taxis in real time.

The statistical information collector 210 may collect a location of a caller calling a taxi, a time that the caller calls the taxi, and a call waiting time during which the caller waits for the taxis.

The zone generator 220 may group the location of the caller based on the call waiting time, may generate a waiting time zone, and may set the call waiting time as a group waiting time in the waiting time zone. Since the call waiting time is variable over time even in the same location, the zone generator 220 may generate waiting time zones for each time based on a time at which the caller calls the taxi.

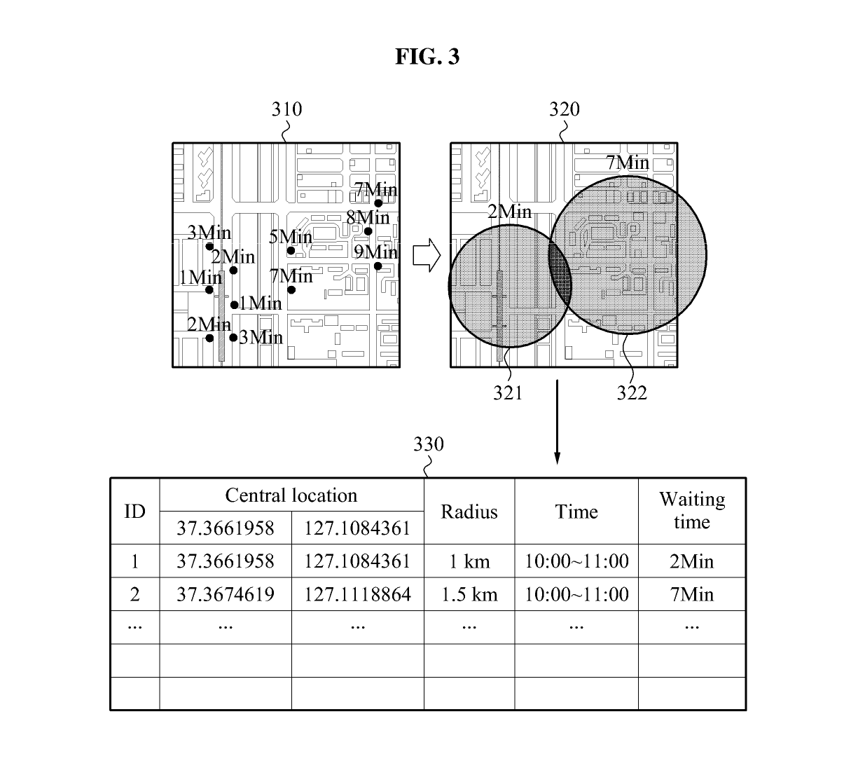

As shown in a map 310 of FIG. 3, the statistical information collector 210 of FIG. 2 may collect locations of callers calling taxis, and call waiting times during which the callers wait for the taxis in the locations.

Subsequently, the zone generator 220 may group the locations of the callers, and may generate waiting time zones 321 and 322, as shown in a map 320 of FIG. 3.

The zone generator 220 may set, as a group waiting time, 2 minutes for the waiting time zone 321 generated by grouping locations corresponding to the call waiting times ranging from 1 minute to 3 minutes in the map 310 of FIG. 3.

Additionally, the zone generator 220 may set, as a group waiting time, 7 minutes for the waiting time zone 322 generated by group locations corresponding to the call waiting times ranging from 5 minutes to 9 minutes in the map 310 of FIG. 3.

Furthermore, the zone generator 220 of FIG. 2 may set information on a central location, a size (e.g., radius), a time, and a waiting time that are associated with the generated waiting time zones 321 and 322, and may store and manage the set information, as shown in a table 330 of FIG. 3.

The taxi waiting time computing unit 230 may compute a taxi waiting time during which a user waits for a taxi, based on the starting point.

When the starting point is in a zone where location information of a taxi is provided in connection with a taxi company, the taxi waiting time computing unit 230 may identify a taxi in a location closest to the starting point, and may compute, as a taxi waiting time, a travel time taken by the identified taxi to travel to the starting point.

Additionally, when the starting point is outside the zone, the taxi waiting time computing unit 230 may estimate an approximate waiting time based on information generated by the statistical information collector 210 and the zone generator 220.

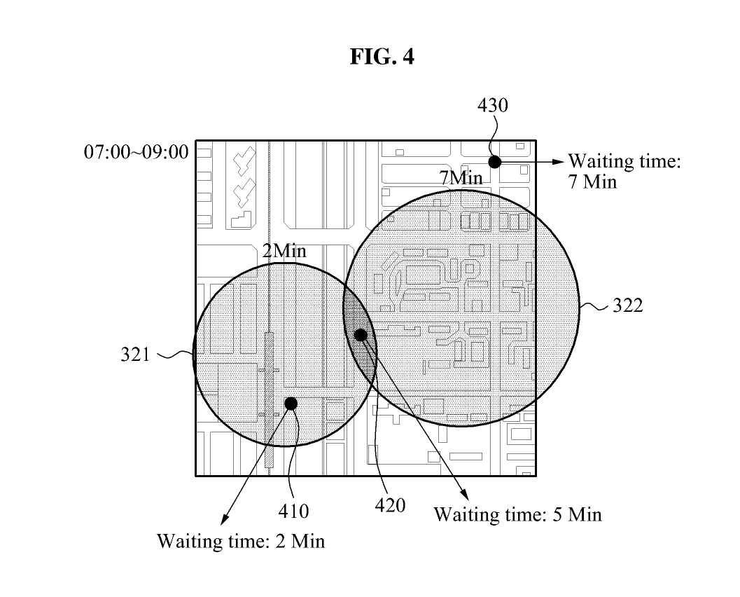

The taxi waiting time computing unit 230 may determine whether the starting point is within one of waiting time zones corresponding to a time that the starting point is input. For example, when a starting point is input at 8:00, the taxi waiting time computing unit 230 may determine whether the starting point is within one of the waiting time zones 321 and 322 that are generated between 7:00 and 9:00, as shown in FIG. 4.

In this example, when the starting point is determined to be within the waiting time zone 321, as indicated by reference numeral 410 of FIG. 4, the taxi waiting time computing unit 230 may compute, as a taxi waiting time, a group waiting time of 2 minutes in the waiting time zone 321.

Additionally, when the starting point is determined to be within both the waiting time zones 321 and 322 as indicated by an overlapped area 420 of FIG. 4, the taxi waiting time computing unit 230 may compute, as a taxi waiting time, 5 minutes, based upon an average value of the group waiting time of 2 minutes in the waiting time zone 321 and the group waiting time of 7 minutes in the waiting time zone 322.

Furthermore, when the starting point is determined to be outside the waiting time zones 321 and 322 as indicated by reference numeral 430 of FIG. 4, the taxi waiting time computing unit 230 may compute, as a taxi waiting time, the group waiting time of 7 minutes in the waiting time zone 322 which is closest to the starting point.

The taxi travel time computing unit 240 may compute a travel time taken by a taxi from the starting point to the destination point, based on the real-time traffic information.

The taxi travel time computing unit 240 may compute the travel time of the taxi in the same manner as that used by the car necessary time computing unit 121.

The taxi's total necessary time computing unit 250 may compute a total necessary time for taxi by adding up the taxi waiting time computed by the taxi waiting time computing unit 230 and the travel time computed by the taxi travel time computing unit 240.

FIG. 5 illustrates a block diagram of a configuration of the subway necessary time computing unit 123 of FIG. 1.

The subway necessary time computing unit 123 may be configured to compute a necessary time if the user transportation is via subway. As shown in FIG. 5, the subway necessary time computing unit 123 may include a subway walking information collector 510, a subway waiting time computing unit 520, a subway transfer time computing unit 530, a subway travel time computing unit 540, and a subway's total necessary time computing unit 550.

The subway walking information collector 510 may compute a first subway walking time for walking from the starting point to a subway station closest to the starting point, and a second subway walking time for walking from a subway station closest to the destination point, to the destination point.

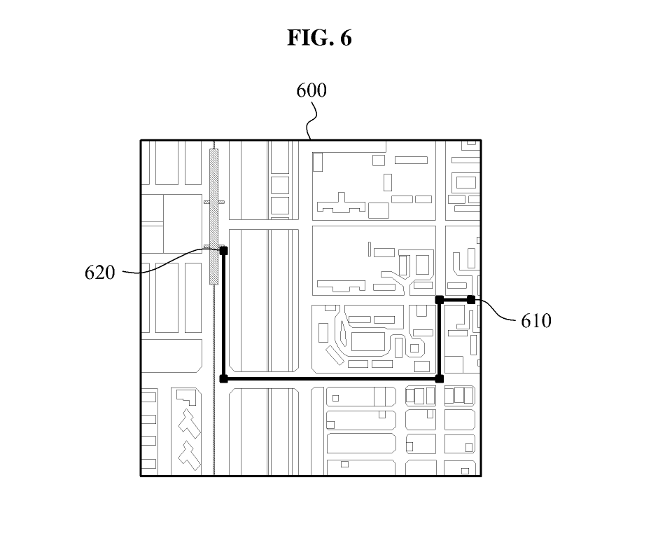

For example, as shown in a map 600 of FIG. 6, the subway walking information collector 510 may search for a subway station 620 that is closest to a starting point 610 using a walking navigation, and may compute a route between the starting point 610 and the subway station 620, and a travel time taken to travel the route.

The subway waiting time computing unit 520 may compute a subway waiting time during which a user waits for a subway, based on subway arrival estimation information for each subway station and/or each subway train line.

For example, the subway waiting time computing unit 520 may receive an estimated time of arrival for each station from a subway corporation, and may compute, as a subway waiting time, a difference between a time that a subway train to be used by a user will arrive at a subway station and a time that the user will arrive at the subway station.

In another example, the subway waiting time computing unit 520 may estimate a time that a subway train used by a user will arrive at a subway station, based on a subway arrival estimation timetable for each station, and may compute, as a subway waiting time, a difference between the estimated time of arrival of the subway train and a time that the user will arrive at the subway station.

The subway waiting time computing unit 520 may compute the subway waiting time using a timetable for each station as shown in TABLE 1, subway station information as shown in TABLE 2, and subway information as shown in TABLE 3.

TABLE 1

| | Station | | | | Train | Arrival | Departure |
|---|---|---|---|---|---|---|---|
| ID | ID | Line | Up/Down | Week | ID | Time | Time |
| 1 | 1907 | 1 | 1 | 1 | K942 | 5:23:30 | 5:24:00 |
| 2 | 1907 | 1 | 1 | 1 | K944 | 5:43:30 | 5:44:00 |
| 3 | 1907 | 1 | 1 | 1 | K946 | 5:55:30 | 5:56:00 |
| 4 | 1907 | 1 | 2 | 1 | K21 | 5:09:00 | 5:09:30 |
| 5 | 1907 | 1 | 2 | 1 | K27 | 5:27:00 | 5:27:30 |
| 6 | 1907 | 1 | 2 | 1 | K31 | 5:39:00 | 5:39:30 |

TABLE 2

| Station ID | Station Name | Latitude | Longitude | Line |
|---|---|---|---|---|
| 1907 | A | 37.74884 | 127.0442 | 1 |
| 1702 | B | 37.48125 | 126.8827 | 1 |
| 1816 | C | 37.46473 | 126.6943 | 1 |
| 1801 | D | 37.49461 | 126.8585 | 1 |
| 1705 | E | 37.41885 | 126.909 | 1 |
| 1750 | F | 37.41713 | 126.8849 | 1 |

TABLE 3

| | | | | | | | | | Whether |
|---|---|---|---|---|---|---|---|---|---|
| | | | | | | Previous | Next | Time left to | train is |
| | Train | | Up/ | Departure | Arrival | Station | Station | reach next | running or |
| TID | ID | Line | Down | Time | Time | ID | ID | station | not |
| 1 | K942 | 1 | 1 | 5:00:00 | 5:28:00 | 1907 | 1908 | 2 | 0 |
| 2 | K944 | 1 | 1 | 5:20:00 | 6:08:30 | 1904 | 1905 | 1 | 0 |
| 3 | K946 | 1 | 1 | 5:32:00 | 6:24:00 | 1021 | 1022 | 5 | 0 |
| 4 | K21 | 1 | 2 | 5:05:00 | 7:09:00 | 1804 | 1804 | 5 | 1 |
| 5 | K27 | 1 | 2 | 5:23:00 | 7:27:00 | 1004 | 1005 | 6 | 1 |
| 6 | K31 | 1 | 2 | 5:35:00 | 7:39:00 | 154 | 154 | 0 | 1 |

Specifically, the subway waiting time computing unit 520 may update a subway operation status at regular intervals.

The subway waiting time computing unit 520 may compare a current time with a departure time and an arrival time in TABLE 3.

As a result of the comparing, when the current time is earlier than the departure time or later than the arrival time, the subway waiting time computing unit 520 may determine that a corresponding train is not running.

Additionally, when the current time is between the departure time and the arrival time, the subway waiting time computing unit 520 may determine that the corresponding train is running, and may extract an ID of the corresponding train.

The subway waiting time computing unit 520 may compute, based on the current time, information on an arrival station, a station prior to the arrival station, and a time left to reach the arrival station. For example, when “K21” is extracted as an ID of a train, and when the current time is “05:06,” the train “K21” may arrive at 05:09 as shown in TABLE 1, and accordingly 3 min may remain.

The subway waiting time computing unit 520 may search for the ID of the corresponding train from the timetable for each station, as shown in TABLE 1, and may determine the arrival station and a station prior to the arrival station.

Subsequently, the subway waiting time computing unit 520 may identify a subway station closest to the starting point based on a location of each station as shown in TABLE 2, and may determine whether a subway train is on an up line or down line, based on route information.

When “whether train is running or not” in TABLE 3 is set to “1”, the subway waiting time computing unit 520 may compute, as a waiting time, a time left to reach a subway station next to a subway station closest to the starting point.

When a subway transfer is required in a travel route between the starting point and the destination point, the subway transfer time computing unit 530 may compute a transfer time by adding up a transfer walking time taken to transfer subway trains within a transfer station, and a waiting time required in the transfer station.

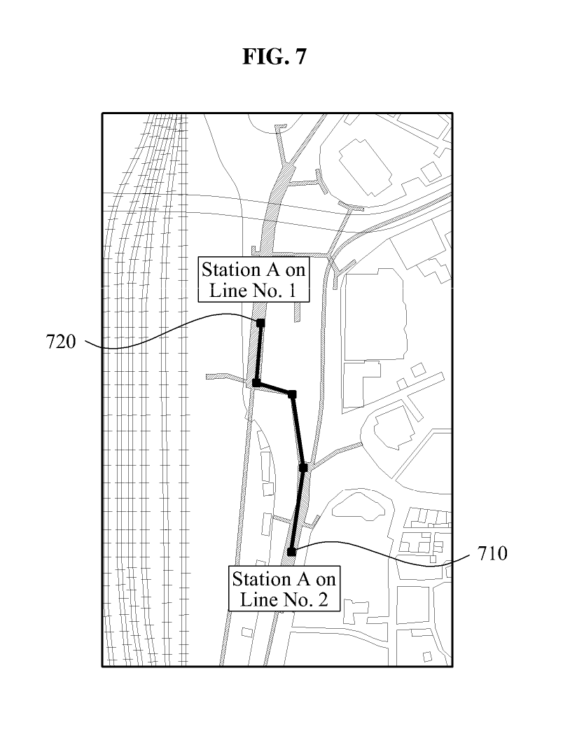

The subway transfer time computing unit 530 may generate a route that a user moves from a No. 2 subway line 710 to a No. 1 subway line 720, based on a transfer station map shown in FIG. 7, and may compute a travel time based on the route as a transfer walking time.

Additionally, the subway transfer time computing unit 530 may compute a transfer time based, at least in part, on the transfer walking time, may transmit the computed transfer time to the subway waiting time computing unit 520, and may receive a time that the user waits after movement to the transfer location.

The subway waiting time computing unit 520 may compute a waiting time required until the user rides in a subway after movement to the transfer location, based on a transfer time and arrival information of a transfer train, and may transmit the computed waiting time to the subway transfer time computing unit 530.

The subway travel time computing unit 540 may compute a subway travel time taken by subway to travel from a subway station closest to the starting point to a subway station closest to the destination.

The subway's total necessary time computing unit 550 may compute a total necessary time for subway by adding up the first subway walking time, the subway waiting time, the subway travel time, and the second subway walking time.

When a subway transfer is required in a travel route between the starting point and the destination point, the subway's total necessary time computing unit 550 may add the transfer time computed by the subway transfer time computing unit 530 to the first subway walking time, the subway waiting time, the subway travel time, and the second subway walking time, and may compute the total necessary time for subway.

FIG. 8 illustrates a block diagram of a configuration of the bus necessary time computing unit 124 of FIG. 1.

The bus necessary time computing unit 124 may be configured to compute a necessary time if the user transportation is via bus. As shown in FIG. 8, the bus necessary time computing unit 124 may include a bus walking information collector 810, a bus waiting time computing unit 820, a bus transfer time computing unit 830, a bus travel time computing unit 840, and a bus's total necessary time computing unit 850.

The bus walking information collector 810 may compute a first bus walking time to walk from the starting point to a bus stop closest to the starting point, and a second bus walking time taken to walk from a bus stop closest to the destination point, to the destination point.

The bus waiting time computing unit 820 may compute a bus waiting time during which a user waits for a bus at the bus stop closest to the starting point, based on bus operating information.

The bus waiting time computing unit 820 may receive, in real time, an estimated time of arrival that a corresponding bus is scheduled to arrive at a corresponding bus stop in association with a bus information system for each region, and may compute, as a bus waiting time, a difference between a time that the user arrives at a bus stop and the received estimated time of arrival.

The bus transfer time computing unit 830 may compute a transfer time when the user transfers to a bus or a subway.

For example, when the user transfers to a bus, the bus transfer time computing unit 830 may compute, as a transfer time, a difference between a time that the user will arrive at a transfer bus stop and a time that a bus to be transferred to will arrive at the transfer bus stop.

Additionally, when the user transfers to a subway, the bus transfer time computing unit 830 may compute a transfer time by adding up a time that the user will arrive at a transfer bus stop where the user is to transfer, a time taken by the user to walk from the transfer bus stop to a subway station, and a difference between a time that the user arrives at the subway station and a time that a subway train where the user is to transfer will arrive at a transfer station where the user is to transfer.

The bus transfer time computing unit 830 may compute a time taken when the user walks from a bus stop to a subway station, in the same manner as in the bus walking information collector 810, or the subway walking information collector 510, and the subway transfer time computing unit 530.

The bus travel time computing unit 840 may compute a bus travel time taken by bus to travel from the bus stop closest to the starting point to the bus stop closest to the destination point.

Since a bus may use an exclusive bus lane different from a car lane, a bus travel time may vary depending on a specific day of the week or a specific time, rather than depending on real-time traffic conditions. Accordingly, the bus travel time computing unit 840 may collect travel speeds of an exclusive bus lane for each time slot, and may compute the bus travel time based on the collected travel speeds.

The bus's total necessary time computing unit 850 may compute a total necessary time for bus by adding up the first bus walking time, the bus travel time, the bus waiting time, and the second bus walking time.

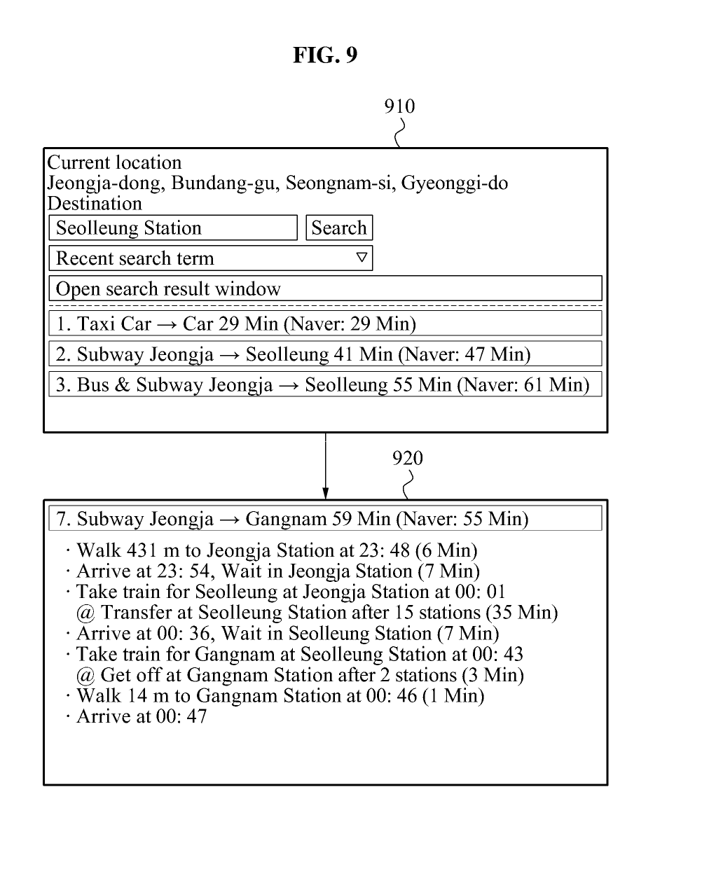

FIG. 9 illustrates a diagram of an example of information displayed on the display unit 130 of FIG. 1.

Referring to 910 in FIG. 9, the display unit 130 may display, on a top line, a transportation requiring the shortest necessary time, and then may display other transportations in an order of increasing longest necessary times.

Referring to 920 in FIG. 9, when a user selects a transportation from among the displayed transportations, the display unit 130 may also display a detailed route and a time for each route based on the selected transportation. For example, in FIG. 9, a detailed route and timings for subway transportation may displayed in response to the user selecting item 2 (i.e., subway) in 910.

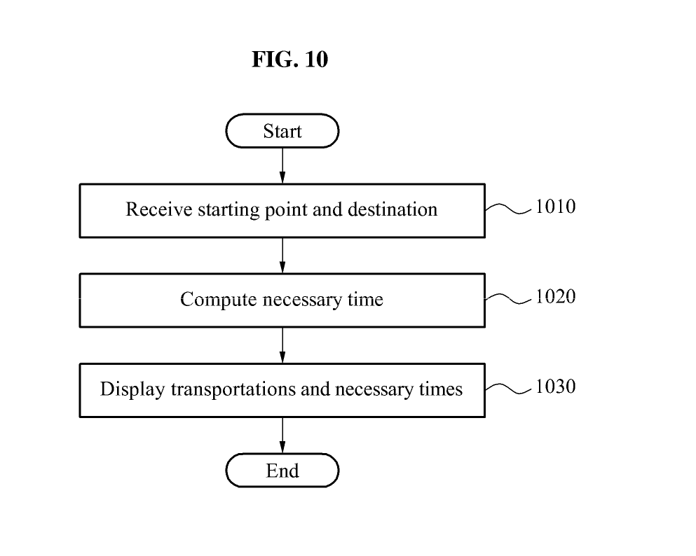

FIG. 10 illustrates a flowchart of a method of computing a necessary time for travel according to exemplary embodiments of the present invention.

In 1010, the input unit 110 may receive information regarding a starting point and a destination point which are input by a user.

In 1020, the necessary time computing unit 120 may compute, for various types of transportation, a necessary time taken to travel from the starting point to the destination point.

The necessary time computing unit 120 may add a waiting time taken until a user rides or uses a particular transportation mode, and a travel time taken by the particular transportation mode to travel to the destination, and may compute a necessary time for the particular transportation mode.

For example, the taxi necessary time computing unit 122 of the necessary time computing unit 120 may compute a taxi waiting time during which a user may wait for a taxi, and a travel time taken by taxi to travel from the starting point to the destination point, and may compute a necessary time for taxi by adding up the taxi waiting time and the travel time. In this example, the taxi necessary time computing unit 122 may collect statistical information associated with a taxi, and may compute the taxi waiting time using waiting time zones generated by grouping locations of callers, based on the collected statistical information.

In another example, the subway necessary time computing unit 123 of the necessary time computing unit 120 may compute a first subway walking time taken to walk from the starting point to a subway station closest to the starting point, a subway waiting time during which the user may wait for a subway in the subway station closest to the starting point, a subway travel time, and a second subway walking time taken to walk from a subway station closest to the destination point, to the destination point. Additionally, the subway necessary time computing unit 123 may compute a necessary time for subway by adding up the computed first subway walking time, the computed subway waiting time, the computed subway travel time, and the computed second subway walking time.

In another example the bus necessary time computing unit 124 of the necessary time computing unit 120 may compute a first bus walking time taken to walk from the starting point to a bus stop closest to the starting point, a bus waiting time during which the user may wait for a bus in the bus stop closest to the starting point, a bus travel time, and a second bus walking time taken to walk from a bus stop closest to the destination point, to the destination point. Additionally, the bus necessary time computing unit 124 may compute a necessary time for bus by adding up the computed first bus walking time, the computed bus waiting time, the computed bus travel time, and the computed second bus walking time.

In 1030, the display unit 130 may display various modes of transportation and necessary times for each of the transportation modes in an ascending order of necessary time, based on the necessary time computed in 1020.

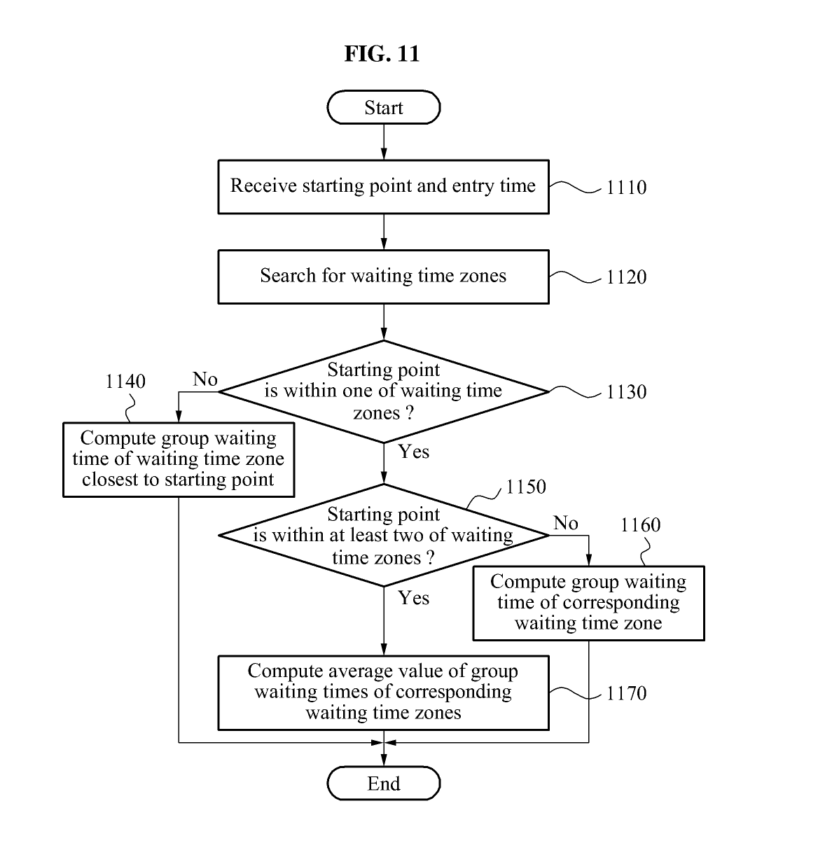

FIG. 11 illustrates a flowchart of a method of computing a taxi waiting time according to exemplary embodiments of the present invention.

In 1110, the taxi waiting time computing unit 230 may receive, from the user via input unit 110, the starting point and an entry time corresponding to a the starting time.

In 1120, the taxi waiting time computing unit 230 may search for waiting time zones corresponding to the entry time received in 1110.

In 1130, the taxi waiting time computing unit 230 may determine whether the starting point received in 1110 is within one of the waiting time zones found in 1120.

When it is determined that the starting point is outside the waiting time zones in 1130, the taxi waiting time computing unit 230 may compute, as a taxi waiting time, a group waiting time of a waiting time zone that is closest to the starting point in 1140.

When it is determined that the starting point is within one of the waiting time zones in 1130, the taxi waiting time computing unit 230 may determine whether the starting point is within at least two of the waiting time zones in 1150.

When it is determined that the starting point is not within at least two of the waiting time zones in 1150, the taxi waiting time computing unit 230 may compute, as a taxi waiting time, a group waiting time of a waiting time zone in which the starting point is included in 1160.

When it is determined that the starting point is within the at least two of the waiting time zones in 1150, the taxi waiting time computing unit 230 may compute, as a taxi waiting time, an average value of group waiting times of waiting time zones in which the starting point is included in 1170.

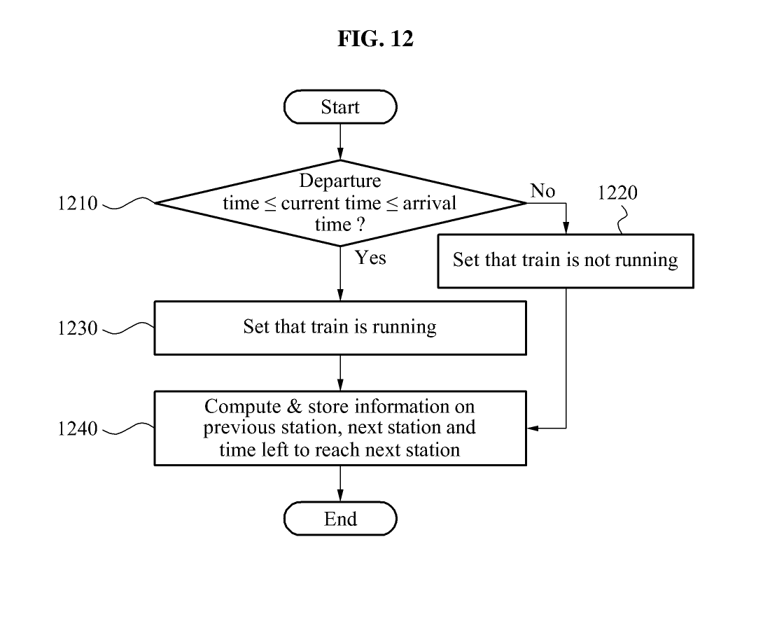

FIG. 12 illustrates a flowchart of a method by which the subway waiting time computing unit 520 of FIG. 5 updates a subway operation status.

In 1210, the subway waiting time computing unit 520 may determine whether a current time is between a departure time and an arrival time of each train in a subway system.

When it is determined that the current time is earlier than the departure time, or later than the arrival time in 1210, the subway waiting time computing unit 520 may set that a corresponding train is not running in 1220.

When it is determined that the current time is between the departure time and the arrival time in 1210, the subway waiting time computing unit 520 may set that a corresponding train is running, and may extract an ID of the corresponding train in operation 1230.

In 1240, the subway waiting time computing unit 520 may compute, based on the current time, information on a previous station, an arrival station, and a time left to reach the arrival station that correspond to the ID of the corresponding train in TABLE 1, and may store the computed information in TABLE 1. Specifically, the subway waiting time computing unit 520 may search for the ID of the corresponding train from the timetable for each station, as shown in TABLE 1, and may compute the previous station and the arrival station.

Therefore, according to exemplary embodiments of the present invention, it is possible to compute a necessary time for travel by adding up a waiting time taken until a user uses a particular transportation mode to travel from a starting point to a destination point, and a travel time taken by the particular transportation mode and thus, it is possible to minimize an error in computing the necessary time for travel.

Additionally, it is possible to compute a necessary time for travel for each of a plurality of transportations, and to display the plurality of transportations in an ascending order of necessary time, so that a user may select an optimal transportation from among the plurality of transportations.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to compute a necessary time for travel, the system comprising:
an input unit to receive a starting point and a destination point;
a necessary time computing unit to compute, for each transportation, a necessary time, the necessary time comprising a travel time from the starting point to the destination point, and the waiting time comprising a time until a user rides in a transportation; and
a display unit to display each transportation and a necessary time for each transportation, based on the necessary time computed by the necessary time computing unit.

2. The system of claim 1, wherein the necessary time computing unit comprises:
a taxi necessary time computing unit to compute the necessary time if the transportation is a taxi;
a subway necessary time computing unit to compute the necessary time if the transportation is a subway; and
a bus necessary time computing unit to compute the necessary time if the transportation is a bus.

3. The system of claim 2, wherein the taxi necessary time computing unit comprises:
a taxi waiting time computing unit to compute, based on the starting point, a taxi waiting time corresponding to a period of time for waiting for a taxi;
a taxi travel time computing unit to compute, based on real-time traffic information, a travel time taken by the taxi to travel from the starting point to the destination point; and
a taxi's total necessary time computing unit to compute a total necessary time for the taxi by adding the taxi waiting time and the travel time.

4. The system of claim 3, wherein, in response to the starting point being in a zone where location information of a taxi is provided, the taxi waiting time computing unit identifies a taxi in a location closest to the starting point, and computes, as a taxi waiting time, a travel time taken by the identified taxi to travel to the starting point.

5. The system of claim 3, further comprising:
a statistical information collector to determine a location from where the taxi is called, a time when the taxi is called, and a call waiting time corresponding to a time for waiting for the called taxi; and
a zone generator to group the location of the caller based on the call waiting time, to generate a waiting time zone, and to set the call waiting time as a group waiting time in the waiting time zone,
wherein the taxi waiting time computing unit determines whether the starting point is included in the waiting time zone, and computes, as the taxi waiting time, a group waiting time of the waiting time zone in which the starting point is included.

6. The system of claim 5, wherein, in response to the starting point being outside the waiting time zone, the taxi waiting time computing unit computes, as the taxi waiting time, a group waiting time of a waiting time zone closest to the starting point.

7. The system of claim 5, wherein, when the starting point is in a plurality of waiting time zones, the taxi waiting time computing unit computes, as the taxi waiting time, an average value of group waiting times of the plurality of waiting time zones.

8. The system of claim 5, wherein the zone generator provides a waiting time zone for each time, based, at least in part, on the time that the caller calls the taxi, and
wherein the taxi waiting time computing unit identifies a zone in which the starting point is included from a waiting time zone corresponding to a time that the starting point is input.

9. The system of claim 2, wherein the subway necessary time computing unit comprises:
a subway walking information collector to compute a first subway walking time and a second subway walking time, the first subway walking time comprising a time to walk from the starting point to a subway station closest to the starting point, and the second subway walking time comprising a time to walk from a subway station closest to the destination point, to the destination point;
a subway waiting time computing unit to compute, based on subway arrival estimation information for each subway station, a subway waiting time corresponding to a period of time for waiting for a subway in the subway station closest to the starting point;
a subway travel time computing unit to compute a subway travel time, the subway travel time comprising a time for the subway to travel from the subway station closest to the starting point to the subway station closest to the destination point; and
a subway's total necessary time computing unit to compute a total necessary time for the subway by adding the first subway walking time, the subway waiting time, the subway travel time, and the second subway walking time.

10. The system of claim 9, further comprising:
a subway transfer time computing unit to compute a transfer time by adding up a transfer walking time and a waiting time in response to a subway transfer being required in a route between the starting point and the destination point, the transfer walking time comprising a time for transferring from a first subway train to a second subway train in a transfer station, and the waiting time comprising a time to wait to board the second subway train in the transfer station,
wherein the subway's total necessary time computing unit further adds the transfer time, and computes the total necessary time.

11. The system of claim 2, wherein the bus necessary time computing unit comprises:
a bus walking information collector to compute a first bus walking time and a second bus walking time, the first bus walking time comprising a time to walk from the starting point to a bus stop closest to the starting point, and the second bus walking time comprising a time to walk from a bus stop closest to the destination point, to the destination point;
a bus waiting time computing unit to compute, based on bus operation information, the bus waiting time corresponding to a period of time for waiting for a bus in the bus stop closest to the starting point;
a bus travel time computing unit to compute a bus travel time, the bus travel time comprising a time for the bus to travel from the bus stop closest to the starting point to the bus stop closest to the destination; and
a bus's total necessary time computing unit to compute a total necessary time for the bus by adding the first bus walking time, the bus waiting time, the bus travel time, and the second bus walking time.

12. The system of claim 10, wherein the bus travel time computing unit collects travel speeds of an exclusive bus lane during each time slot, and computes the bus travel time based on the collected travel speeds.

13. The system of claim 1, wherein the display unit displays, first, a transportation requiring a shortest necessary time, and displays other transportations in an order from second shortest to longest necessary times.

14. A method for computing a necessary time for travel, the method comprising:
receiving a starting point and a destination point;
computing, for each transportation, a necessary time, the necessary time comprising a time to travel from the starting point to the destination point, and the waiting time comprising a time until a user rides in a transportation; and
displaying each transportation and a necessary time for each transportation, based on the computed necessary time.

15. The method of claim 14, wherein the computing of the necessary time comprises:
computing the necessary time if the transportation is a taxi;
computing the necessary time if the transportation is a subway; and
computing the necessary time if the transportation is a bus.

16. The method of claim 15, wherein computing the necessary time if the transportation is the taxi comprises:
computing, based on the starting point, a taxi waiting time corresponding to a period of time for waiting for a taxi;
computing, based on real-time traffic information, a travel time being taken by the taxi to travel from the starting point to the destination point; and
computing a total necessary time for the taxi by adding the taxi waiting time and the travel time.

17. The method of claim 16, wherein computing the taxi waiting time further comprises:
identifying a taxi in a location closest to the starting point in response to the starting point being in a zone where location information of a taxi is provided; and
computing, as a taxi waiting time, a travel time taken by the identified taxi to travel to the starting point.

18. The method of claim 16, further comprising:
determining a location from where a taxi is called, a time when the taxi is called, and a call waiting time corresponding to a time for waiting for the called taxi; and
grouping the location of the caller based on the call waiting time, and generating a waiting time zone; and
setting the call waiting time as a group waiting time in the waiting time zone,
wherein the computing of the taxi waiting time comprises determining whether the starting point is in the waiting time zone, and computing, as the taxi waiting time, a group waiting time of the waiting time zone in which the starting point is included.

19. The method of claim 18, wherein computing the taxi waiting time comprises computing, as the taxi waiting time, a group waiting time of a waiting time zone closest to the starting point in response to the starting point being outside the waiting time zone.

20. The method of claim 18, wherein, in response to the starting point being included in a plurality of waiting time zones, the computing of the taxi waiting time comprises computing, as the taxi waiting time, an average value of group waiting times in the plurality of waiting time zones.

21. The method of claim 18, wherein the grouping comprises providing a waiting time zone for each time based on the times that the caller calls the taxi, and
wherein computing the taxi waiting time comprises identifying a zone in which the starting point is included from a waiting time zone corresponding to a time that the starting point is input.

22. The method of claim 15, wherein computing the necessary time if the transportation is the subway comprises:
computing a first subway walking time, the first subway walking time comprising a time to walk from the starting point to a subway station closest to the starting point;
computing, based on subway arrival estimation information for each subway station, a subway waiting time corresponding to a period of time for waiting for a subway in the subway station closest to the starting point;
computing a subway travel time, the subway travel time comprising a time for a subway to travel from the subway station closest to the starting point to the subway station closest to the destination point;
computing a second subway walking time, the second subway walking time comprising a time to walk from a subway station closest to the destination point, to the destination point; and
computing a total necessary time for subway by adding the first subway walking time, the subway waiting time, the subway travel time, and the second subway walking time.

23. The method of claim 22, further comprising:
in response to a subway transfer being required in a route between the starting point and the destination point, computing a transfer time by adding a transfer walking time and a waiting time, the transfer walking time comprising a time for transferring from a first subway train to a second subway train in a transfer station, and the waiting time comprising a time to wait to board the second subway train in the transfer station,
wherein the computing of the total necessary time further comprises adding the transfer time, and computing the total necessary time.

24. The method of claim 15, wherein computing the necessary time when the transportation is the bus comprises:
computing a first bus walking time, the first bus walking time comprising a time to walk from the starting point to a bus stop closest to the starting point;
computing, based on bus operation information, the bus waiting time corresponding to a period of time for waiting for a bus in the bus stop closest to the starting point;
computing a bus travel time, the bus travel time comprising a time for the bus to travel from the bus stop closest to the starting point to the bus stop closest to the destination;
computing a second bus walking time, the second bus walking time comprising a time to walk from a bus stop closest to the destination point, to the destination point; and
computing a total necessary time for bus by adding the first bus walking time, the bus waiting time, the bus travel time, and the second bus walking time.

25. The method of claim 24, wherein computing the bus travel time further comprises collecting travel speeds of an exclusive bus lane for each time slot, and computing the bus travel time based on the collected travel speeds.

26. The method of claim 24, wherein displaying comprises displaying, first, a transportation requiring a shortest necessary time, and displaying other transportations in an order from second shortest to longest necessary times.
